(19) United States
(12) Patent Application Publication
(10) Pub. No.: US 2025/0035212 A1
(43) Pub. Date: Jan. 30, 2025

(54) SEAL ASSEMBLY

(71) Applicant: Teal Sales Incorporated, Lynnwood, WA (US)

(72) Inventors: Matthew Bernard McLaughlin Hoffman, Poulsbo, WA (US); Mark Roland Harrington, Eatonville, WA (US); Andrew Philip Twitchell, Snohomish, WA (US); William Benny Teal, Lynnwood, WA (US)

(21) Appl. No.: 18/782,613

(22) Filed: Jul. 24, 2024

Related U.S. Application Data
(60) Provisional application No. 63/529,113, filed on Jul. 26, 2023.

(51) Int. Cl. F16J 15/3268; C10B 1/10; C10B 53/02

(52) U.S. Cl. CPC F16J 15/3268; C10B 1/10; C10B 53/02

(57) ABSTRACT

A seal assembly is provided that transitions from an expanded configuration to a retracted configuration. In the expanded configuration, the seal assembly forms a non-permeable seal between a rotatable rigid body and a non-rotatable rigid body, the non-permeable seal preventing the entry of oxygen into a reactor drum having a low oxygen environment and/or leakage of gases produced in the low oxygen environment of the reactor drum to the surrounding environment. In the retracted configuration, the rotatable rigid body is secured relative to the non-rotatable rigid body such that relative rotation is prevented. The first rigid body may be translatable relative to the second rigid body to reduce a length of the seal assembly and facilitate rapid removal and/or replacement of the seal assembly from between adjacent components of a torrefaction, gasification, or pyrolysis system.

### CROSS-REFERENCE TO RELATED APPLICATION

This application claims the benefit of provisional Application No. 63/529,113, filed Jul. 26, 2023, the disclosure of which is hereby incorporated by reference in its entirety herein.

### BACKGROUND

### Technical Field

This disclosure generally relates to systems with rotating and stationary components, such as pyrolysis, torrefaction, and or gasification systems, and more specifically relates to a seal assembly positioned between the rotating and stationary components of the system.

### Description of the Related Art

Torrefaction/pyrolysis/gasification of biomass particles is well known and is a process in which biomass and/or other organic particles are heated in a low oxygen environment. This causes volatile compounds within the particles to be boiled off and the cellular structure of the particles to be degraded, resulting in a partial loss of mass and an increase in friability. Torrefaction/pyrolysis/gasification also causes a reaction within the remaining cellular structure that enhances the moisture resistance of the resulting product. The particles that remain after undergoing a torrefaction/pyrolysis/gasification process have an enhanced energy value when measured in terms of heat energy per unit of weight. The degree and quality of torrefaction/pyrolysis/gasification of biomass and/or other organic particles depends on several factors, including composition, the level of heat applied, the length of time the heat is applied, and surrounding gas conditions (particularly with respect to oxygen level).

Current torrefaction/pyrolysis/gasification systems include seal assemblies that limit the amount of oxygen entering the system, thereby maintaining the low oxygen environment. The points of entry and exit for biomass particles into and out of such systems, in particular systems wherein a rotating drum that contains at least a portion of the low oxygen environment, are areas of particular concern for potential oxygen infiltration. Known systems include high precision seals disposed between the rotating drum and static components adjacent the rotating drum. Operation of the system results in wear of these high precision seals, eventually leading to failure if not replaced beforehand. Replacement of these known, high precision seals involves disassembly of the system, removal and replacement of the seals, and reassembly of the system with the replacement seals in place. This known replacement process is time consuming, and results in long down times.

### BRIEF SUMMARY

Embodiments described herein provide systems and methods which are particularly well adapted for torrefying organic particles (including in particular cellulosic biomass particles) of various sizes in an efficient and consistent manner. Torrefaction, gasification, and pyrolysis (TGP) reactions are similar in nature, primarily differentiated by the range of temperatures at which the reaction is performed. For the purposes of this disclosure, TGP reactions broadly include the thermochemical decomposition of organic compounds in a manner where oxidizing agents are controlled or entirely eliminated. For the purposes of this disclosure, use of the terms “torrefaction,” “pyrolysis,” and “gasification” are understood to be interchangeable unless specifically noted otherwise.

According to one embodiment, a TGP system may be summarized as including an inlet to receive particles (e.g., biomass particles), a reactor drum rotatable about its longitudinal axis, a heat source that heats gas contained in the system to a temperature sufficient to initiate and sustain a TGP reaction of the particles within the reactor drum during operation of the system, a ventilator that, when the system is in operation, moves the gas heated by the heat source to form a flow of heated gas through the reactor drum sufficient to sustain TGP reaction of the particles within the reactor drum along the length of the reactor drum as the particles interact with the heated gas stream as the reactor drum rotates.

The TGP system may include gas ducts coupled to at least the reactor drum, heat source, and fan device to recirculate a portion of gas or gasses exiting the reactor drum back to the heat source to reheat the gas for reintroduction into the reactor drum. The TGP system may further include a hopper located downstream of the reactor drum to collect solid particles exiting the reactor drum and to discharge the solid particles from the system. The system may further include at least one airlock located between the inlet and the reactor drum to limit the amount of oxygen entering the system when receiving the particles.

The system may further include at least one seal assembly between the reactor drum and adjacent structures. The seal assembly may maintain separation of the contents of the reactor drum and the surrounding atmosphere (e.g., may prevent infiltration of oxygen from the surrounding environment into the reactor drum). The TGP system may include a mechanism coupled to an inert or semi-inert gas or steam source for selective purging of the reactor drum (e.g., during a startup or shutdown operation) to maintain an oxygen free environment within the reactor drum.

According to one embodiment, a TGP seal system may include a plurality of sealing elements per seal assembly, and a mechanism coupled to an inert or semi-inert gas or steam source for selective purging of the area between multiple sealing elements to maintain an oxygen free environment within the reactor drum. The purging pressure is maintained relative to the pressures of both the drum and atmosphere to create a barrier to any flow of gasses from the drum to the atmosphere or the atmosphere to the drum.

According to one embodiment, a seal assembly includes first, second, and third rigid members, at least one compressible member, and at least one biasing member. The first rigid member includes a first rigid body and a first hole extending through the first body. The second rigid member includes a second rigid body and a second hole extending through the second body. The third rigid member includes a third rigid body and a third hole extending through the third body.

The at least one compressible member is positioned between and abuts both the second rigid member and the third rigid member such that a seal is formed between the second rigid member and the third rigid member. The seal, when combined with other features, is an effective gas impermeable barrier. It is understood by those skilled in the art that in the current context, “airtight” may refer to an obstruction of flow of a single or a plurality of gasses, and is not limited to air. In the interest of brevity, the term “airtight” may be used to define the seal in this disclosure to define a barrier preventing the free flow of a gas or mixture of gasses and gas phase compounds.

The at least one biasing member is positioned between the first rigid member and the second rigid member such that the at least one biasing member exerts a force that biases the third rigid member away from the first rigid member and toward the second rigid member. The seal assembly includes an expanded configuration in which the second rigid member is rotatable relative to both the first rigid member and the third rigid member, and the third rigid member is translatable relative to the first rigid member.

According to one embodiment, a method of performing maintenance on a torrefaction, gasification, or pyrolysis system includes attaching a tensioner to a first rigid body and a second rigid body, thereby preventing rotation of the second rigid body relative to the first rigid body. The method further includes removing fasteners that coupled the first rigid body to a non-rotatable component of the system, actuating the tensioner to translate the first rigid body toward the second rigid body, thereby compressing a biasing member that is positioned between the first rigid body and the second rigid body. The method further includes removing fasteners that coupled the second rigid body to a rotatable component of the system, and simultaneously moving both the first rigid body and the second rigid body relative to both the rotatable component of the system and the non-rotatable component of the system.

### BRIEF DESCRIPTION OF THE SEVERAL VIEWS OF THE DRAWINGS

FIG. 1 is a schematic diagram of a torrefaction, gasification, or pyrolysis system according to one embodiment.

FIG. 2 is a cross-sectional, schematic diagram of a portion of the torrefaction, gasification, or pyrolysis system illustrated in FIG. 1, with the system in operation.

FIG. 3 is a cross-sectional, schematic diagram of the portion of the torrefaction, gasification, or pyrolysis system illustrated in FIG. 2, while maintenance is being performed on the system.

FIG. 4 is a cross-sectional, schematic diagram of a seal assembly of the system illustrated in FIG. 2, at one stage of the maintenance process.

FIG. 5 is a cross-sectional, schematic diagram of the seal assembly illustrated in FIG. 4, at one stage of the maintenance process.

FIG. 6 is a cross-sectional, schematic diagram of the seal assembly of the system illustrated in FIG. 4, at one stage of the maintenance process.

FIG. 7 is a cross-sectional, schematic diagram of the seal assembly illustrated in FIG. 4, at one stage of the maintenance process.

FIG. 8 is a cross-sectional, schematic diagram of a seal assembly of the system illustrated in FIG. 2, according to one embodiment.

FIG. 9 is a cross-sectional, schematic diagram of another portion of the torrefaction, gasification, or pyrolysis system illustrated in FIG. 1, the system including a second seal assembly.

FIG. 10 is a cross-sectional view of the reactor drum of FIG. 1, according to one embodiment.

FIG. 11 is a cross-sectional, side view of a portion of the torrefaction, gasification, or pyrolysis system illustrated in FIG. 1, at stage of the maintenance process.

FIG. 12 is an isometric view of a portion of the torrefaction, gasification, or pyrolysis system illustrated in FIG. 11, at one stage of the maintenance process.

FIG. 13 is an enlarged, isometric view of a portion of the torrefaction, gasification, or pyrolysis system illustrated in FIG. 12.

FIG. 14 is an isometric view of a tensioner of the torrefaction, gasification, or pyrolysis system illustrated in FIG. 13.

FIG. 15 is an isometric view of a portion of the torrefaction, gasification, or pyrolysis system illustrated in FIG. 11, at one stage of the maintenance process.

FIG. 16 is an isometric view of a portion of the torrefaction, gasification, or pyrolysis system illustrated in FIG. 11, at one stage of the maintenance process.

FIG. 17 is an isometric view of a portion of the torrefaction, gasification, or pyrolysis system illustrated in FIG. 11, at one stage of the maintenance process.

FIG. 18 is a front elevation view of a portion of the torrefaction, gasification, or pyrolysis system illustrated in FIG. 11, at one stage of the maintenance process.

FIG. 19 is an isometric view of a lifting arm of the torrefaction, gasification, or pyrolysis system illustrated in FIG. 18.

FIG. 20 is an isometric view of a slide leg of the torrefaction, gasification, or pyrolysis system illustrated in FIG. 18.

FIG. 21 is an isometric view of a guide roller of the torrefaction, gasification, or pyrolysis system illustrated in FIG. 18.

FIG. 22 is a side elevation view of a seal assembly of the torrefaction, gasification, or pyrolysis system illustrated in FIG. 11, with the seal assembly removed from the system.

FIG. 23 is a side elevation view of the seal assembly illustrated in FIG. 22, during the maintenance process.

FIG. 24 is an isometric view of a portion of the seal assembly illustrated in FIG. 23, at one stage of the maintenance process.

FIG. 25 is an side elevation view of a portion of the seal assembly illustrated in FIG. 24, at one stage of the maintenance process.

FIG. 26 is an isometric view of a portion of the seal assembly illustrated in FIG. 24, at one stage of the maintenance process.

FIG. 27 is an isometric view of a portion of the seal assembly illustrated in FIG. 24, at one stage of the maintenance process.

### DETAILED DESCRIPTION

In the following description, certain specific details are set forth in order to provide a thorough understanding of various disclosed embodiments. However, one skilled in the relevant art will recognize that embodiments may be practiced without one or more of these specific details. In other instances, well-known structures or steps associated with industrial process equipment and industrial processes may not be shown or described in detail to avoid unnecessarily obscuring descriptions of the embodiments.

For instance, it will be appreciated by those of ordinary skill in the relevant art that various sensors (e.g., temperature sensors, oxygen sensors, etc.), control devices and other industrial process controls may be provided and managed via a programmable logic controller (PLC) or other suitable control system for monitoring the systems described herein and controlling operational parameters of the processes to optimize or tailor characteristics of the resultant torrefied particles.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics described herein may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

Recitation of ranges of values herein are merely intended to serve as a shorthand method of referring individually to each separate value falling within the range including the stated ends of the range, unless otherwise indicated herein, and each separate value is incorporated into the specification as if it were individually recited herein.

The headings and Abstract of the Disclosure provided herein are for convenience only and do not interpret the scope or meaning of the embodiments.

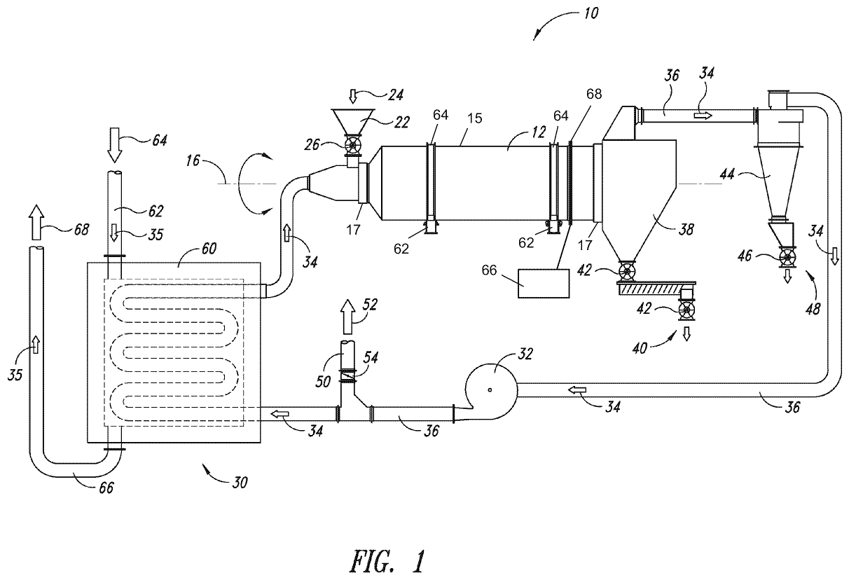

FIG. 1 shows a schematic of a system 10 (e.g., a torrefaction, gasification, and/or pyrolysis system) according to one example embodiment. The system 10 may include a reaction chamber or vessel (referred to herein as a reactor drum 12) supported so as to rotate about a longitudinal axis 16 of the reactor drum 12. The reactor drum 12 includes an inner volume that may be cylindrical, as shown, or another tubular shape (e.g., rectangular, square, irregular, etc.). The tubular shape of the inner volume of the reactor drum 12 may correspond to a shape of an outer wall 15 of the reactor drum 12.

The shape of the inner volume may be constant along some or all of the length of the reactor drum 12, or the shape may change (e.g., taper) along the length of the reactor drum 12. The system 10 may further include an inlet 22 that receives particles (e.g., biomass particles) that are to be processed, as represented by the arrow labeled 24. An airlock or dual airlock 26 with optional inert or semi-inert gas purge or similar device may be coupled to the inlet 22 to substantially prevent oxygen from entering the system 10 when particles are fed into the system 10. The particles may be fed to the inlet 22 via a conveyor or other conventional material transport mechanism. In one embodiment, a plug-feed screw conveyor may be used in lieu of the airlock(s) to create a plug of material that acts as a seal when passing particles through the inlet 22.

The system 10 may further include a heater 30 disposed upstream of the reactor drum 12. The heater 30 may supply heat to a gas stream 34 generated within the system 10 (e.g., by a ventilator 32, such as a fan device). According to one embodiment, the ventilator 32 may be, for example, an induced draft fan device or a forced draft fan device. The ventilator 32 may be operable to draw or force gas through the reactor drum 12 and circulate the gas (or a substantial portion of the gas) back to the heater 30 to be reheated and supplied to the reactor drum 12 in a recirculating manner. In some embodiments, eighty percent or more of the gas by volume exiting the reactor drum 12 may be recirculated to the inlet of the reactor drum 12. In some embodiments, ninety percent or more of the gas by volume exiting the reactor drum 12 is recirculated to the inlet of the reactor drum 12. In some embodiments, ninety-five percent or more of the gas by volume exiting the reactor drum 12 is recirculated to the inlet of the reactor drum 12.

During operation, the gas stream 34 may act as a thermal fluid to carry heat energy to the particles within the reactor drum 12. According to one embodiment, the gas stream 34 may also provide momentum for conveyance of the particles. The gas stream 34 may also heat the internal structure of the reactor drum 12, (e.g., a number of lifting flights or other structure within the reactor drum 12 that directly contacts the particles), which may also in turn heat the particles.

The system 10 may include gas ducts 36, appropriately sized and coupled to at least the reactor drum 12, heater 30 and ventilator 32 to recirculate the gas stream 34 in the system 10. According to one embodiment, a portion up to an entire amount of gas entering the reactor drum 12 is recirculated back to the inlet of the reactor drum 12 in a continuous manner. In some embodiments, no new gas (other than unintended leakage) is supplied to the recirculating gas stream 34 during operation.

As shown in the illustrated embodiment, the heater 30 may be in the form of a gas-to-gas heat exchanger 60. A hot gas stream 35 (e.g., in the range of about 800° F. to about 2400° F.) may be supplied to the heat exchanger 60 via an inlet conduit 62, as represented by the arrow labeled 64. The hot gas stream 35 may interact with the recirculating gas stream 34 of the torrefaction system 10 to transfer heat thereto. In some embodiments, the heat exchanger 60 may be configured to raise the inlet temperature of the torrefaction gas stream 34 into the heat exchanger 60 from about 500° F.±100° F. to an outlet temperature of about 900° F.±150° F. In doing so the temperature of the other isolated gas stream 35 in the heat exchanger 60 is lowered before exiting the heat exchanger 60 via an outlet conduit 66.

The temperature of the other isolated gas stream 35, may still be sufficiently hot to be useful in other processes (e.g., drying the biomass particles prior to entry via the inlet 22). Accordingly, in some embodiments, the gas stream 35 discharged from the heat exchanger 60 via the outlet conduit 66 may be routed to a dryer system or other device, as represented by the arrow labeled 68. In some embodiments, the discharged gas stream 35 may be routed back to the inlet of the heat exchanger 60 and blended with other heated gas having a higher temperature, such as, for example, a remote burner, to regulate the inlet temperature of the heat exchanger 60 to a desired level or to fall within a desired temperature range.

Although the illustrated embodiment of the heater 30 is shown as a gas-to-gas heat exchanger 60, it is appreciated that other various heaters 30 may be provided. For example, in some embodiments, an electric immersion-type heater may be provided within the path of the gas stream 34 of the biomass torrefaction system 10. In other embodiments, low oxygen burners may be directed directly into the system 10 to heat the gas stream 34 without significantly increasing the oxygen level within the system 10. Isolating the gas stream 34 in a recirculating manner may facilitate maintenance of a low level oxygen environment within the reactor drum 12 that is conducive to torrefying biomass particles.

At the downstream end of the reactor drum 12, a separator hopper 38 may be provided that collects torrefied biomass particles (e.g., torrefied wood chips, torrefied giant cane chips, and other torrefied cellulosic biomass) as the particles exit the reactor drum 12. These particles may then be fed mechanically and/or under the force of gravity towards an outlet 40 for collection. One or more airlock devices 42 may be coupled to the outlet 40 to limit/prevent oxygen from infiltrating the system 10 as the torrefied particles are withdrawn from the system 10.

Smaller particles (e.g., torrefied wood fines, torrefied giant cane fines, other torrefied cellulosic biomass) which may pass through the separator hopper 38 can be filtered and removed from the gas stream 34 by a filtering device 44, such as, for example a cyclonic type filtering device. One or more additional airlock devices 46 may be coupled to a secondary outlet 48 for removing the filtered material from the system 10 without introducing significant amounts of oxygen into the system 10.

A chamber or space between a pair of sequentially aligned airlocks 42, 46 may be coupled to an inert or semi-inert gas source for selective purging of the chamber or space. In some embodiments, the torrefaction system 10 may include a cyclonic type filtering device in lieu of a hopper 38 to separate and/or filter torrefied biomass particles from the gas stream 34. In some embodiments, the torrefaction system 10 may include one or more pneumatic discharge devices to discharge torrefied biomass particles from the torrefaction system 10.

As previously described, the gas stream 34 may be drawn or forced through the reactor drum 12 and returned to the heat source 30 (after separating torrefied particles, chips, fines, dust and/or any debris) under the influence of the ventilator 32. While the substantial majority of the gas is recirculated, some gas may be diverted to exhaust ducting 50. The gas exhausted through the exhaust ducting 50 may be used elsewhere in the process or another process, as represented by the arrow labeled 52. For instance, the exhaust gas may be used as fuel to generate heat to aid the heat source 30 in increasing the temperature of the gas stream 34. The exhaust ducting 50 can include a variable position damper 54 which may be used to balance the pressure inside the reactor drum 12 from slightly negative to slightly positive. Depending on the setting, this can be used to inhibit oxygen from entering the system 10.

According to one embodiment, the system 10 may include a plurality of stages with different temperatures, retention times, chemistry and/or operational conditions. The plurality of stages may be mechanically isolated from one another.

The system 10 may, for example, contain multiple drums with airlocks and hoppers. The system 10 may also include drums that provide isolation between sections using solids, for example progressive screw features, conical geometry, circulating/fluidized solids trap, and or porting. The system 10 may use solids that are involved in the TGP process, or independent of the TGP process for example ceramic media and or sand. The system 10 may include features, cavities, ducting and/or other components that add and/or remove elements and/or compounds from the gas stream 34 between mechanically isolated sections.

Torrefaction, gasification, and/or pyrolysis of the particles within reactor drum 12 may release compounds (e.g., hydrocarbons in a gaseous phase) that enter and mix with the gas stream 34. The system 10 may include components that vent or exhaust an amount of gas from the gas stream 34 so as to maintain a relatively steady pressure within the system 10.

As shown in the illustrated embodiment, the reactor drum 12 may be supported in a horizontal orientation on a number of rollers 62. The roller(s) 62 may contact the reactor drum 12 along bearing tracks 64 that are secured to the outer wall 15 of the reactor drum 12 (e.g., about a circumference of the reactor drum 12). The diameter of the reactor drum 12 may be three feet, four feet, five feet, or more (e.g., up to twenty feet or more), and may be configured to receive and process over fifty tons of torrefied biomass particles per hour.

The system 10 may include a drive motor 66 coupled to a drive belt or chain 68 that selectively rotates the reactor drum 12 at various speeds, such as, for example, about 3 rpm or more or less. Seal assemblies 17 may be disposed between the rotating reactor drum 12 and adjacent, static components (e.g., the inlet 22, the separator 38, etc.) to limit/prevent infiltration of oxygen into the system 10 thereby maintaining the gas stream at a consistent low level of oxygen by creating a substantially sealed vessel.

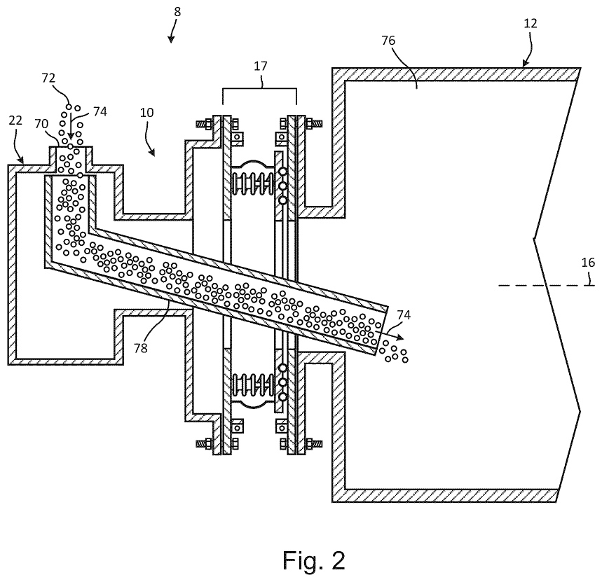

Referring to FIG. 2, the seal assembly 17 may be positioned between the inlet 22 that receives particles 72 to be processed by the system 10 and the reactor drum 12 within which the particles 72 are processed. As shown, the inlet 22 may include an entry 70 through which particles 72 enter the system 10. The particles 72 may follow a path 74 through the inlet 22, into and through the seal assembly 17, and into an inner volume 76 of the reactor drum 12. The system 10 may include a material chute 78 positioned (e.g., at least partially within the inlet 22) such that the material chute 78 forms at least a portion of the path 74. As shown, the particles 72 may travel along/through the material chute 78 (e.g., when passing through the seal assembly 17).

The system 10 may include components that limit and/or prevent entry of oxygen into the inner volume 76 of the reactor drum 12 along the path 74. According to one embodiment, the inlet 22 may include an airlock (e.g., the airlock 26 as shown in FIG. 1) that allows passage/entry of the particles 72 into the inlet 22 while purging oxygen from the system 10 and preventing that oxygen from entering the inlet 22 and the inner volume 76. According to one embodiment, the particles 72 may be in the form of a plug that corresponds in shape to the entry 70, such that entry of oxygen is limited and/or prevented by a seal formed between the plug and the entry 70. Thus, the system 10 may be devoid of an airlock.

The seal assembly 17 may be attached to both the reactor drum 12 and another component of the system 10 nearby/adjacent the reactor drum 12 (e.g., the inlet 22) so as to limit and or prevent entry of oxygen and/or other gases in an external environment 8 surrounding the system 10 into the inner volume 76 via a path between a joint formed by a stationary surface (e.g., secured relative to the inlet 22) abutting a rotating surface (e.g., secured relative to the reactor drum 12). According to one embodiment, the reactor drum 12 is rotatable relative to other components of the system 10 (e.g., the inlet 22). Thus, the seal assembly 17 may form a seal between a first, stationary component (e.g., the inlet 22) and a second, rotatable/rotating component (e.g., the reactor drum 12).

Relative rotation of the first and second components may result in increased wear on components within reactor seals, due to increased friction as a result of the relative rotational movement. Entry of oxygen into the inner volume 76 during a TGP reaction may result in an explosion or deflagration within the reactor drum 12. To prevent these undesired outcomes, the seals are regularly replaced. Replacement often involves disassembly of multiple components, and may be a time consuming process.

According to one embodiment, the seal assembly 17 is removable from the system 10 all at once (i.e., as a single, connected “cartridge”). Upon removal of the seal assembly 17, another seal assembly 17 may be installed. Thus, the system 10 may continue operation while maintenance is performed on the removed seal assembly 17. In addition to the increased efficiency and decreased downtime, the seal assembly 17 being removable as a cartridge may also improve accessibility to the components of the seal assembly 17, as it may be manipulated and positioned more freely once it is removed from the adjacent components of the system 10.

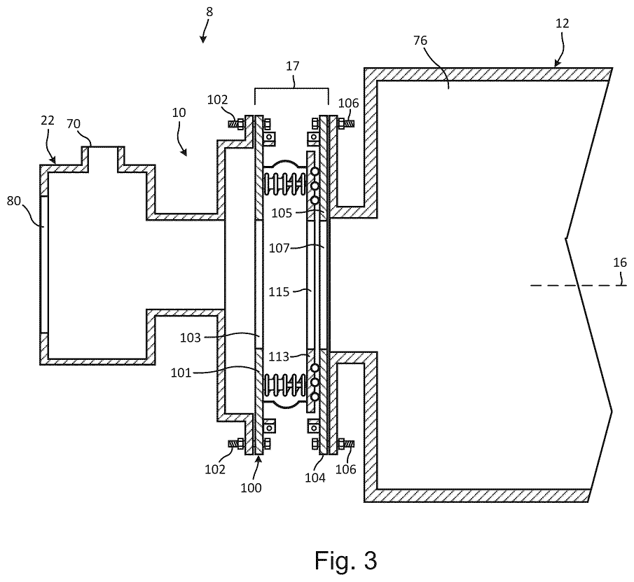

Referring to FIGS. 2 to 5, operation of the system 10 may be discontinued during maintenance of the system 10 (e.g., removal and/or replacement of the seal assembly 17). Components extending through the seal assembly 17 (i.e., components that would block movement/removal of the seal assembly 17) may be removed. As shown in FIG. 3, entry of the particles 72 into the inlet 22 via the entry 70 may be suspended, and the material chute 78 may be removed from the inlet 22 (e.g., through an access hatch 80 formed in the inlet 22).

The seal assembly 17 may include a length L1 that is variable by transitioning the seal assembly 17 from an expanded configuration (e.g., as shown in FIGS. 2 to 5) to a contracted configuration (e.g., as shown in FIGS. 6 and 7). As shown, the length L1 may be measured along a direction D1, and the direction D1 may be substantially parallel to (e.g., parallel to) the longitudinal axis 16 of the reactor drum 12 about which the reactor drum 12 rotates, when the seal assembly 17 is secured to the reactor drum 12. In the expanded configuration, the length L1 is greater than when the seal assembly 17 is in the contracted configuration.

According to one embodiment, the seal assembly 17 may include a first rigid member 100 (e.g., a plate, disc, bracket, etc. that does not easily deform when contacted/pressure is applied thereto). For example, the first rigid member 100 may be made from a metal (e.g., aluminum, steel, iron, titanium, etc.) or non-metals (e.g., graphite, Kevlar composite, carbon fiber, etc.). The first rigid member 100 may include a first rigid body 101 and a first hole 103 that extends through the first rigid body 101. The first rigid body 101 may be circular with a center that intersects the first hole 103.

As shown, the first rigid member 100 may be securely coupled to the inlet 22 such that the relative position and orientation of the first rigid member 100 with respect to the inlet 22 is fixed. The first rigid member 100 may be directly or indirectly (e.g., via a bracket or other connector) coupled to the inlet 22 (e.g., via one or more fasteners 102).

According to one embodiment, the seal assembly 17 may include a second rigid member 104 (e.g., a plate, disc, bracket, etc. that does not easily deform when contacted/pressure is applied thereto). For example, the second rigid member 104 may be made from a metal (e.g., aluminum, steel, iron, titanium, etc.) or non-metal(s) (e.g., graphite, Kevlar composite, carbon fiber, etc.). The second rigid member 104 may include a second rigid body 105 and a second hole 107 that extends through the second rigid body 105. The second rigid body 105 may be circular with a center that intersects the second hole 107.

As shown, the second rigid member 104 may be securely coupled to the reactor drum 12 such that the relative position and orientation of the second rigid member 104 with respect to the reactor drum 12 is fixed. The second rigid member 104 may be directly or indirectly (e.g., via a bracket or other connector) coupled to the reactor drum 12 (e.g., via one or more fasteners 106). According to one embodiment, when the first rigid member 100 is securely coupled to the inlet 22 and the second rigid member 104 is securely coupled to the reactor drum 12, the centers of first rigid body 101 and the second rigid body 105 may be aligned (e.g., aligned with the longitudinal axis 16).

When the system 10 is in operation, the first rigid member 100 may be securely coupled to the inlet 22, and the second rigid member 104 may be securely coupled to the reactor drum 12, the second rigid member 104 may be rotatable relative to the first rigid member 100 about an axis of rotation (e.g., about the longitudinal axis 16). Additionally, when the system 10 is in operation, the seal assembly 17 forms an effectively airtight seal between a stationary component 108 of the seal assembly 17 and a rotatable/rotating component 110 of the seal assembly 17.

As shown, the stationary component 108 may include a third rigid member 112 (e.g., a plate, disc, bracket, etc. that does not easily deform when contacted/pressure is applied thereto). For example, the third rigid member 112 may be made from a metal (e.g., aluminum, steel, iron, titanium, etc.) or non-metal(s) (e.g., graphite, Kevlar composite, carbon fiber, etc.). The third rigid member 112 may include a third rigid body 113 and a third hole 115 that extends through the third rigid body 113. The third rigid body 113 may be circular with a center that intersects the third hole 115.

According to one embodiment, the seal assembly 17 may include a biasing member 114 that exerts a force against one or both of the first rigid member 100 and the third rigid member 112 that moves or attempts to move the first rigid member 100 and the third rigid member 112 away from each other. As shown, the biasing member 114 may include a spring 116 (e.g., positioned between the first rigid member 100 and the third rigid member 112) that exerts an “outward” force on surfaces of the first rigid member 100 and the third rigid member 112 that face one another.

The rotatable/rotating component 110, according to one embodiment, may be the second rigid member 104. Alternatively, the second rigid member 104 may be another component (e.g., a plate, disc, bracket, etc. that does not easily deform when contacted/pressure is applied thereto).

The seal assembly 17 may include at least one compressible member 118 (e.g., a seal, such as an o-ring). As shown the at least one compressible member 118 may be positioned between the stationary component 108 and the rotatable/rotating component 110 to cooperatively form the airtight seal. The seal assembly 17 may include a lone compressible member 118, or multiple compressible members 118 to make the airtight seal redundant. As shown, at least one of the at least one compressible member 118 may include a plurality of the compressible members 118 positioned concentrically, and may include a mechanism coupled to an inert or semi-inert gas or steam source for selective purging of the area between multiple sealing elements 118 to maintain an oxygen free environment within the reactor drum 12. The purging pressure may be maintained relative to the pressures of both the inner volume 76 of the reactor drum 12 and external environment 8 (e.g., atmosphere) to further create a barrier to any flow of gasses from the inner volume 76 of the reactor drum 12 to the external environment 8, or from the external environment 8 to the inner volume 76 of the reactor drum 12.

Each of the at least one compressible member 118 may be positioned within a respective groove 120 formed within the stationary component 108 or the rotatable/rotating component 110. According to one embodiment, each of the compressible members 118 may be positioned within one of the grooves 120 that is formed in the stationary component 108. According to one embodiment, each of the compressible members 118 may be positioned within one of the grooves 120 that is formed in the rotatable/rotating component 110. According to one embodiment, at least one of the compressible members 118 may be positioned within one of the grooves 120 formed in the stationary component 108 and at least one other of the compressible members 118 may be positioned within one of the grooves 120 formed in the rotatable/rotating component 110.

The airtight seal may be formed between two members (e.g., the stationary component 108 and the rotatable/rotating component 110), as shown. Alternatively, the airtight seal may be formed between more than two members (i.e., including one of the compressible members 118 positioned between a first stationary component 108 and the rotatable/rotating component 110, and another of the compressible members 118 positioned between a second stationary component 108 and the rotatable/rotating component 110).

The one or more compressible members 118 may be formed of a material (e.g., synthetic rubber, thermoplastic, composite, etc.) that easily (e.g., more easily than the first rigid member 100) deforms when contacted/pressure is applied thereto. In use, the force exerted by the biasing member 114 urges the third rigid member 112 toward the second rigid member 104 thereby compressing the one or more compressible members 118 positioned between the second rigid member 104 and the third rigid member 112. The compression of the one or more compressible members 118 forms the airtight seal between the second rigid member 104 and the third rigid member 112, preventing passage of oxygen from the external environment 8 between the stationary component 108 and the rotatable/rotating component 110 and into the reactor drum 12.

The seal assembly 17 may include an expandable member 122 that forms an airtight seal between two or more of the stationary components (as shown), or between two or more of the rotatable/rotating components 110. According to one embodiment, the expandable member 122 may be coupled to the first rigid member 100 and the third rigid member 112 so as to form an airtight seal between the first rigid member 100 and the third rigid member 112. The expandable member 122 may be coupled to the first rigid member 100 and the third rigid member 112 such that the expandable member 122 maintains the airtight seal regardless of whether the seal assembly 17 is in the expanded configuration or the contracted configuration.

According to one embodiment, the expandable member 122 may be flexible or stretchable to maintain the airtight seal as the length L1 changes.

According to one embodiment, the expandable member 122 may include an expansion portion 124 (i.e., a bulge or slack) that changes in shape to accommodate the changing length L1. For example, the expansion portion 124 may be larger (i.e., a more prominent bulge) when the seal assembly 17 is in the contracted configuration, and the expansion portion 124 may shrink (i.e., into a less prominent bulge) as the seal assembly 17 transitions to the expanded configuration. The expandable member 122 may be a tubular member (e.g., that encloses a plurality of the biasing members 114).

The system 10 (e.g., the seal assembly 17) may include a number of tensioning devices (i.e., a tensioner), such as turnbuckles 130. Each of the turnbuckles 130 may be attached to both a stationary component 132 (e.g., the first rigid member 100) of the seal assembly 17 and a rotatable component 134 (e.g., the second rigid member 104) of the seal assembly 17. According to one embodiment, attachment of the turnbuckles 130 to both the stationary component 132 and the rotatable component 134 prevents relative rotation between the stationary component 132 and the rotatable component 134. As shown, the stationary component 132 (e.g., the first rigid member 100) and the rotatable component 134 (e.g., the second rigid member 104) may include a number of brackets 136 that form pairs, with each pair cooperatively receiving a respective one of the turnbuckles 130.

As illustrated in FIG. 5, the turnbuckles 130 may be attached to respective pairs of the brackets 136, and then the fasteners 102 (as shown) or the fasteners 106 may be removed. With the fasteners 102 or the fasteners 106 removed the turnbuckles 130 may be actuated to change (e.g., decrease) the length L1, thereby transitioning the seal assembly 17 from the expanded configuration to the contracted configuration, as shown in FIG. 6. Actuation (e.g., rotation of a portion) of the turnbuckles 130 may exert a force on the stationary component 132 and the rotatable component 134 sufficient to overcome the biasing force exerted by the biasing members 114. Thus, actuation of the turnbuckles 130 may compress the biasing members 114 resulting in the length L1 of the seal assembly 17 decreasing.

According to one embodiment, a hoist 140 may be positioned to lift/move the seal assembly out from between the inlet 22 and the reactor drum 12. The hoist 140 may be attached to one or more dedicated attachment points (e.g., hooks, loops, etc.). According to one embodiment, the hoist 140 may be attached to a lifting arm 142 that may be attached to a pair of the brackets 136, after removal of the respective turnbuckle 130. Alternatively, the hoist 140 may be attached to one or more of the turnbuckles 130. With the seal assembly 17 in the contracted configuration, the other of the fasteners 102 and the fasteners 106 (e.g., the fasteners 106 as shown) may be removed. A lifter 144 (e.g., crane, forklift, jack, etc.) may then move (e.g., raise as indicated by arrow 146) the seal assembly 17 thereby removing the seal assembly from the system 10.

The process may then be repeated, in reverse, to attach a replacement seal assembly 17 (or the original seal assembly 17 after maintenance has been complete) to the inlet 22 and the reactor drum 12, and resume operation of the system 10. With the seal assembly 17 physically separated/removed from the system 10, maintenance may be performed (e.g., removal of one or more of the compressible members 118 from their respective groove 120, and replacement with a new one of the compressible members 118.

According to one embodiment, the system 10 (e.g., the seal assembly 17) may include a wear detector 150, as shown in FIG. 6, that collects information during operation of the system 10 to determine the status of the seal assembly 17 (e.g., including the wear condition of the one or more compressible members 118). The wear detector 150 may include one or more sensors 152 that measure a size of a gap 154 between components that form the airtight seal (e.g., components that abut opposite sides of the one or more compressible members 118). The wear detector may include a laser that is used to measure the size of the gap 154.

As shown if FIG. 7, the sensor(s) 152 may be positioned so as to measure a size of the gap 154 between the stationary component 108 (e.g., the third rigid member 112) and the rotatable/rotating component 110 (e.g., the second rigid member 104). The size of the gap 154 may be measured along a direction (e.g., the direction D1) parallel to the rotational axis 16 of the reactor drum 12. As the system 10 operates, friction resulting from the rotating/non-rotating joint formed by the one or more compressible members 118 may cause the one or more compressible members 118 to deteriorate. As the one or more compressible members 118 deteriorate the size of the gap between the stationary component 108 and the rotatable/rotating component 110 may shrink.

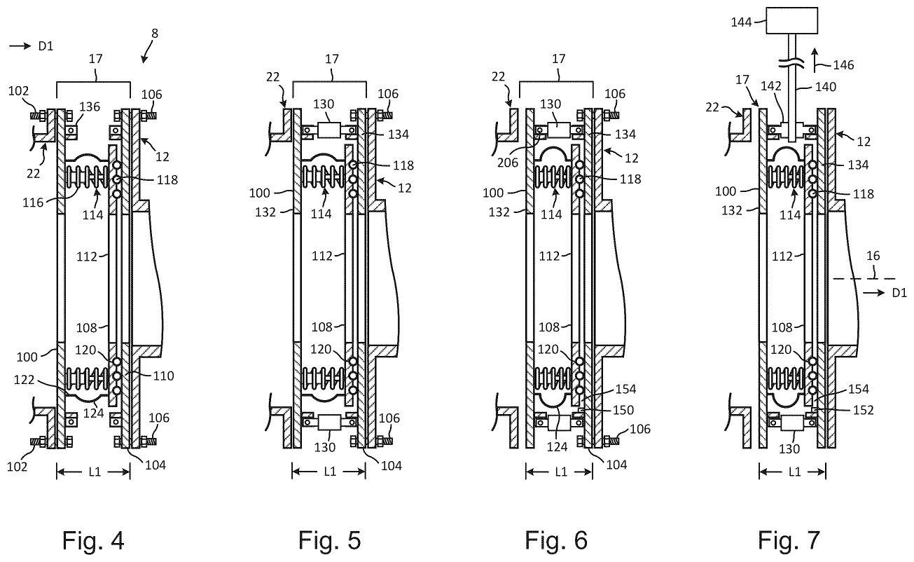

Upon the size of the gap reaching/crossing a threshold value, the wear detector 150 may send a signal (e.g., wirelessly or via a wired connection) to a controller or user interface indicating that the threshold value has been crossed, and that the system 10 should be prepared for maintenance of the seal assembly 17. As shown in FIGS. 4 and 5, the system 10 (e.g., the seal assembly 17) may be devoid of the wear detector 150 (e.g., instead relying on predicted operational lifetimes of the one or more compressible members 118). Although shown with a single sensor 152 in FIG. 7 (for the sake of clarity in the drawings), the system 10 (e.g., the seal assembly 17) may include multiple sensors 152 at various positions.

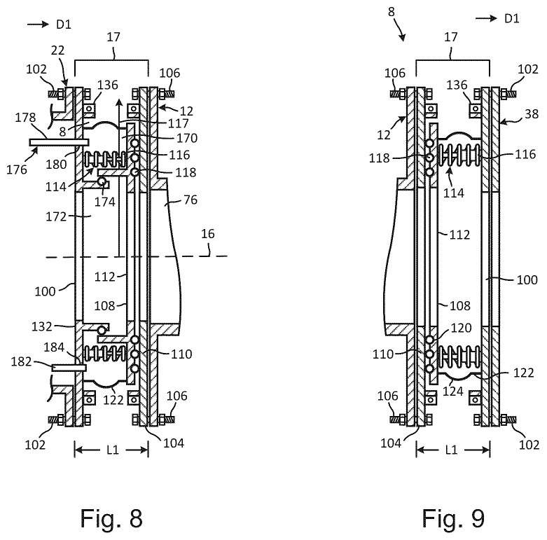

Referring to FIG. 8, the system 10 (e.g., the seal assembly 17) may include a positive pressure zone 170 that helps monitor for and identify leaks within the seal assembly 17. According to one embodiment, the positive pressure zone 170 is positioned between an inner volume 172 of the seal assembly 17 and the external environment 8. As shown, the inner volume 172 of the seal assembly 17 may be fluidly connected to the inner volume 76 of the reactor drum 12. The positive pressure zone 170 may be positioned radially outward from the inner volume 172 (e.g., with respect to the longitudinal axis 16). The positive pressure zone 170 may further be positioned radially inward from the external environment 8 with respect to the longitudinal axis 16, such that a radial ray 117 extending perpendicularly from the longitudinal axis 16 passes through the inner volume 172, then passes through the positive pressure zone 170, before exiting the seal assembly 17 into the external environment 8.

According to one embodiment, the positive pressure zone 170 is formed between two or more stationary components (e.g., the first rigid member 100 and the third rigid member 112). At least one compressible member 174 (e.g., a seal, such as an o-ring) may be positioned between (e.g., in direct contact with) opposed surfaces of the first rigid member 100 and the third rigid member 112. The at least one compressible member 174, the opposed surfaces of the first rigid member 100 and the third rigid member 112, and the expandable member 122 may cooperatively form an airtight seal that is maintained whether the seal assembly 17 is in the expanded configuration, the contracted configuration, or transitioning therebetween. The positive pressure zone 170 being positioned between the inner volume 172 and the external environment 8 may prevent entry of oxygen into the inner volume 172 because a leak would result in the gas within the positive pressure zone 170 leaking out rather than oxygen leaking in.

The system 10 (e.g., the seal assembly 17) may include a gas purge 176 that supplies a gas (e.g., an inert gas such as nitrogen), or a gas phase fluid such as steam, to the positive pressure zone 170. The gas purge 176 may include a gas injector 178 that supplies the gas to the positive pressure zone 170 (e.g., via a port 180 provided in one of the stationary components 132, such as the first rigid member 100). During operation of the system 10, the gas injector 178 may be connected to a gas source (not shown) that supplies gas (e.g., nitrogen) to the gas injector 178, which provides passage for the supplied gas into the positive pressure zone 170. According to one embodiment, the gas is provided to the gas injector 178 at a predetermined pressure (e.g., a pressure higher than the atmospheric pressure of the external environment 8, and higher than the pressure in the inner volume 172, 76). For example, the pressure within the positive pressure zone 170 may be 35 mBar gauge pressure, or more (e.g., greater than both the external environment 8 and the pressure within the inner volume 172 of the seal assembly 17 or the inner volume 76 of the reactor drum 12).

The seal assembly 17 may include a pressure sensor 182 that monitors pressure within the positive pressure zone 170. Detecting a change (e.g., a drop) in pressure within the positive pressure zone 170 may indicate a leak before a major failure occurs. As shown, the pressure sensor 182 may pass through a port 184 in the first rigid member 100 that is located radially opposite the gas injector 178 so as to increase the accuracy of the pressure measured by the pressure sensor 182.

In an embodiment in which the seal assembly 17 includes the gas purge 176, the gas injector 178, the pressure sensor 182, or any combination thereof, those elements that are present may be disconnected and/or removed as part of the maintenance/disassembly process (e.g., prior to transitioning the seal assembly 17 from the expanded configuration to the contracted configuration).

A method of determining a leakage rate of the positive pressure zone 170 (e.g., the one or more compressible members 174) may include installing a flow meter between the gas source and the positive pressure zone 170. Prior to connecting the pressure source to the gas injector 178, the maximum flow rate may be measured (venting into the external environment 8). The gas source may then be connected to the gas injector 178 and the positive pressure zone 170 may be pressurized to an operation pressure (e.g., 35 mBar gauge pressure).

During operation, the flow rate may be constantly monitored, giving a real-time measurement of leakage from the positive pressure zone 170. Depending on operations, the leakage rate may increase or decrease from the baseline leakage rate. A reading that approaches the maximum flow rate should serve as a warning to the operator that there is major leak. This allows the operator to avoid a loss of pressure in the positive pressure zone 170 and proactively prepare for maintenance and bring the reactor to a safe state.

Referring to FIGS. 1 and 9, the system 10 may include more than one of the seal assemblies 17. For example, a first seal assembly 17 may be coupled to an entry end of the reactor drum 12 and a second seal assembly 17 may be coupled to an exit end of the reactor drum 12 positioned between the separator hopper 38. The first and second seal assemblies 17 may be similar such that the description provided above in reference to the seal assembly 17 described in FIGS. 1 to 8 is applicable to the second seal assembly 17. Minor changes may be made to shapes, sizes, etc. to fit the stationary components 108 to the separator hopper 38 or other component of the system 10 that receives the processed particles 72. The second seal assembly 17 may include the positive pressure zone 170 as described in reference to the first seal assembly.

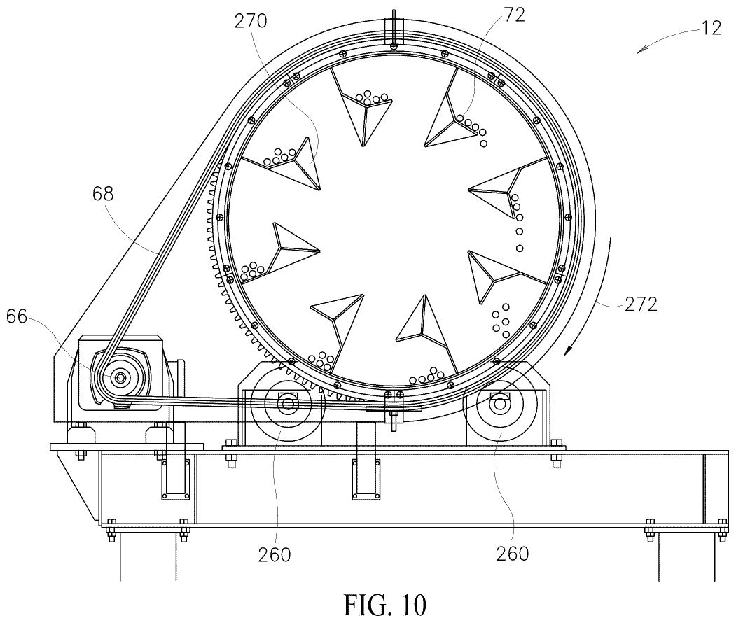

Further details of the reactor drum 12 will now be described with reference to FIG. 10. As shown in the illustrated embodiment, the reactor drum 12 may be supported in a horizontal orientation on a number of rollers 260. The diameter of the drum 12 may be three feet, four feet, five feet, or more (e.g., up to twenty feet or more), and may be configured to receive and process over fifty tons of torrefied biomass particles per hour.

The drive motor 66 may be coupled to the drive belt or chain 68 and controlled via the control system to selectively rotate the drum 12 at various speeds, such as, for example, about 3 rpm or more or less. Within the reactor drum 12, there may be a number of the lifting flights 270 spaced circumferentially at each of a plurality of locations along a longitudinal length thereof. The density of the lifting flights 270 may be designed to suit various needs of the system 10 and may be dependent on a number of interrelated factors, such as, for example, the speed of rotation of the reactor drum 12, the rate of material fed into the system 10, and the speed of the ventilator 32 (shown in FIG. 1) or strength of the heated gas stream passing through the reactor drum 12.

The flights 270 may be configured to lift the particles 72 as the reactor drum 12 rotates in the direction indicated by arrow 272 and then direct and shower the particles 72 into the gas stream to be intermittingly carried along the length of the reactor drum 12 predominately by the kinetic energy of the gas stream and simultaneously torrefied. As shown, the flights 270 may be fixed to the reactor drum 12 such that they rotate about the longitudinal axis 16 with the reactor drum 12. The flights 270 may include a scoop-like shape that scoops up and suspends the particles (e.g., such that the particles are spaced away from a periphery of the reactor drum 12 during at least a portion of the rotation).

For illustration purposes five “particles” 72 are shown being carried by each flight 270. As the flights 270 rotate with the particles 72 in contact with the flights 270, movement of the particles 72 is minimal (or zero). Once the flights 270 reach a certain point in their respective rotation (e.g., about 3 o'clock as shown in FIG. 10) the particles fall out of the flight 270 and are “showered” into the heated gas stream flowing through the reactor drum 12. While falling the heated gas stream carries the particles 72 along a portion of the length of the reactor drum 12.

This is advantageous in that the transport mechanism for the particles provides a highly efficient medium for transferring heat to the particles directly.

Accordingly, large volumes of particles can be processed by a system with reduced energy demands. In addition, the throughput or rate of torrefied biomass particles (tons/hour) may be relatively greater when compared to conventional torrefaction systems of generally comparable size.

The system 10 (e.g., the flights 270 of the reactor drum 12) may be calibrated such that it generally takes a number of rotations of the reactor drum 12 to provide enough forward progress of the particles (via repeated dropping into the heated gas stream) to gain passage through the length of the reactor drum 12. The showering and conveying process within the drum 12 may also classify the particles. Lighter, smaller particles may pass through the drum 12 faster than heavier, larger particles, as the larger, heavier particles fall more quickly and/or are advanced less distance along the length of the reactor drum 12 with each successive “showering” compared to the smaller, lighter particles. This allows large particles to remain in the drum 12 for a relatively longer residence time and creates a more uniform end product (i.e., large and small particles may be processed together to have similar end characteristics despite differences in mass and volume).

For example, in some embodiments, particle size may vary within a particular run of torrefied particles by between ten percent and twenty percent, between ten percent and thirty percent, or more than thirty percent (e.g., up to 100% or more) while the energy density and moisture characteristics of the particles are maintained relatively consistent irrespective of particle size. In some embodiments, the flights 270 may be designed to vary with respect to location and/or flight density in different embodiments to affect the residence time of the particles within the reactor drum 12.

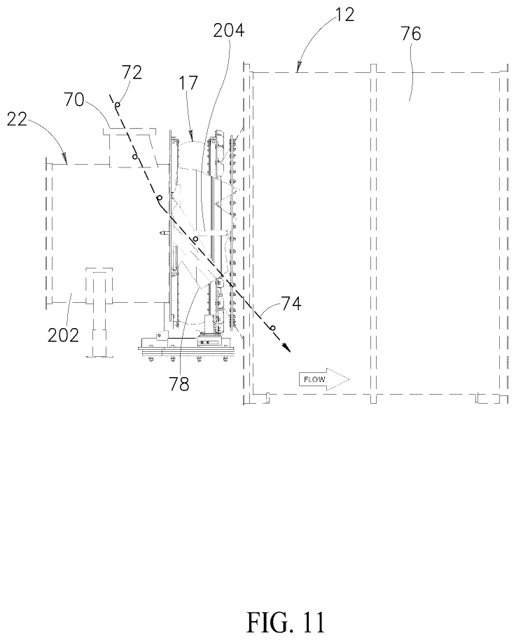

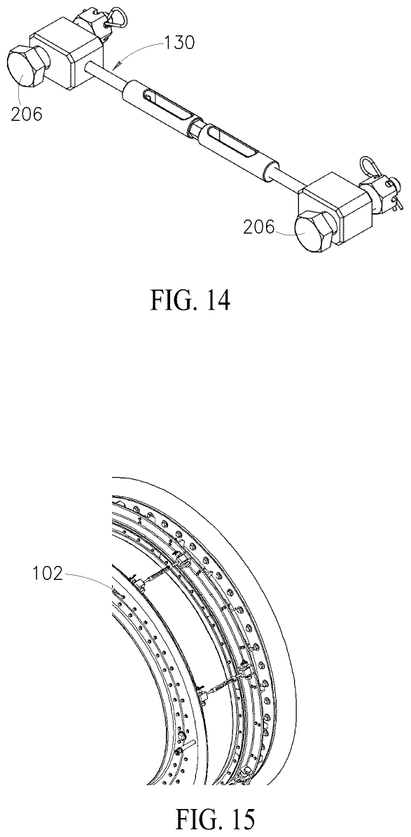

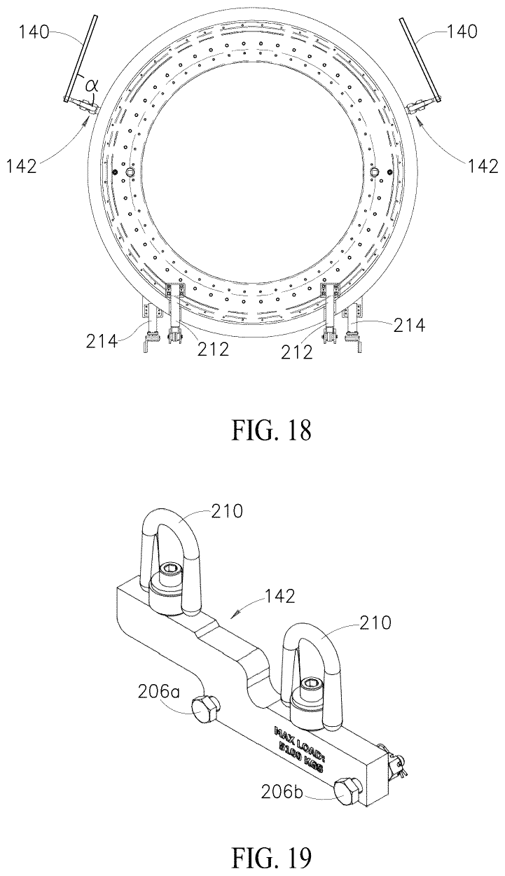

Referring to FIGS. 11 to 27, a method of performing maintenance on a torrefaction, gasification, and/or pyrolysis system (e.g., the system 10) may include replacing a seal assembly (e.g., the seal assembly 17). The method may include removing components/equipment from the inlet 22. As shown in FIG. 11, removing the components/equipment from the inlet 22 may include accessing an interior 202 of the inlet 22, detaching the material chute 78 from the inlet 22 and removing the material chute 78 from the interior 202, clearing debris (e.g., the particles 72) from any inlet nozzle(s) 204 (e.g., that provide passage for the heated gas stream 34 into the inlet 22 and/or the inner volume 76), detach and remove the inlet nozzle(s) 204 from the inlet 22, or any combination thereof.

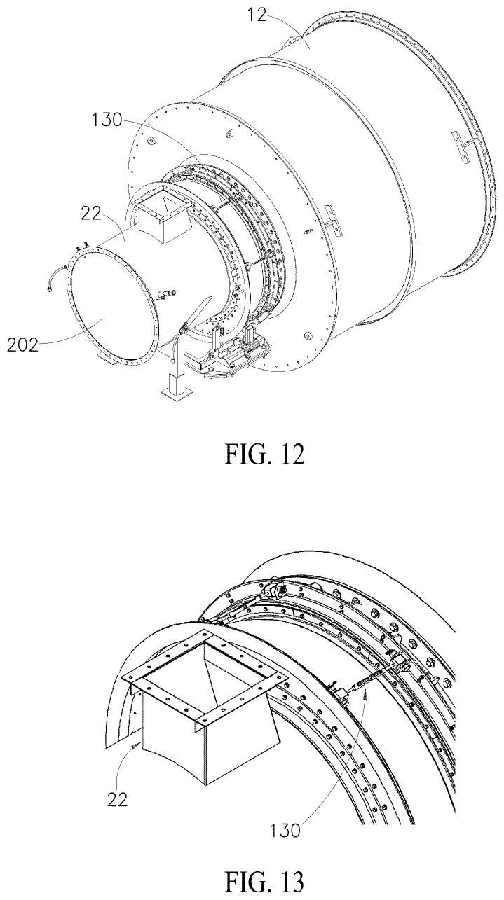

As shown in FIGS. 12 to 15, the method may include installing the turnbuckles 130 (e.g., securing each of the turnbuckles 130 to a respective pair of the brackets 136). As shown, the turnbuckle 130 may include fasteners 206 that are inserted through corresponding holes in the bracket 136 and the turnbuckle 130 and secured therein, thereby securing the turnbuckles 130 to both the first rigid member 100 and the third rigid member 112. The method may include actuating the turnbuckle 130 (e.g., rotating corresponding threads relative to one another) to shorten the turnbuckle 130, and remove any slack between the first rigid member 100 and the third rigid member 112.

After installation of the turnbuckles 130, the fasteners 102 may be removed, thereby decoupling the inlet 22 from the first rigid member 100. According to one embodiment, the fasteners 102 may be removed in an alternating or “star” pattern about a perimeter of the inlet 22. After the fasteners 102 are removed, the method may include transitioning the seal assembly 17 from the expanded configuration to the contracted configuration. Transitioning the seal assembly 17 may include actuating the turnbuckles 130 (similar to as described above). The turnbuckles 130 may be actuated (e.g., incrementally) in an alternating or “star” pattern about a perimeter of the seal assembly 17.

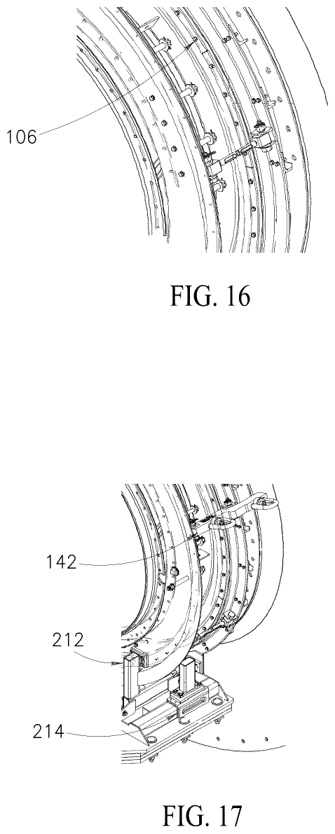

As shown in FIG. 16, the method may include removing the fasteners 106, thereby decoupling the seal assembly 17 from the reactor drum 12.

According to one embodiment, the fasteners 106 may be removed in an alternating or “star” pattern about a perimeter of the second rigid member 104. As shown in FIGS. 17 to 19, the method may include attaching the lifting arm 142 to the seal assembly 17. According to one embodiment, attaching the lifting arm 142 may include removing one or more of the turnbuckles 130 from the seal assembly 17, and replacing each removed turnbuckle 130 with respective ones of the lifting arm 142. The lifting arm 142 may be positioned about a perimeter of the seal assembly 17 such that an angle α from the lifting arm 142 to the hoist 140 is less than 30 degrees.

As shown in FIG. 19, the lifting arm 142 may include fasteners 208 (e.g., similar to the fasteners 206). The lifting arm 142 may be shaped so as to only be securable to the seal assembly 17 in one orientation (e.g., with a first of the fasteners 206a attached to the bracket 136 closer to the reactor drum 12, and with a second of the fasteners 206b attached to the bracket 136 farther from the reactor drum 12. The lifting arm 142 may include one or more dedicated attachment points 210 (e.g., hooks, loops, etc.).

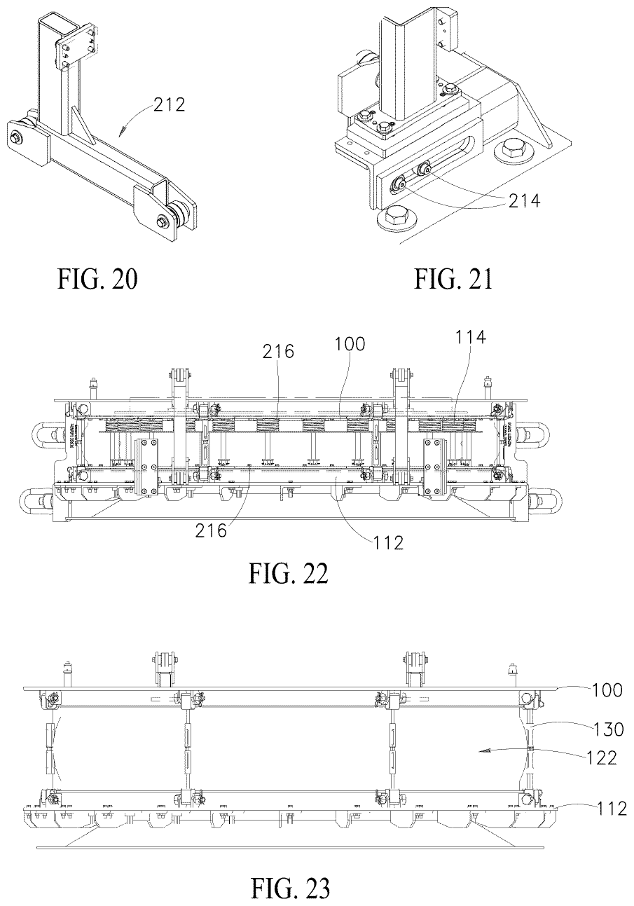

As shown in FIGS. 20 and 21 the seal assembly 17 may include a slide leg 212 and additional supports (e.g., one or more guide rollers 214). The method may include engaging the slide leg 212 with a slot in the first rigid member 100 and removing additional supports (e.g., the guide rollers 214) to facilitate release of the seal assembly 17 from the system 10.

As shown in FIG. 22, the method may include removing the seal assembly 17 from the system 10 (e.g., from between the reactor drum 12 and inlet 22/collection hopper 38) and then positioning the removed seal assembly 17 on a flat surface (e.g., orientated 90 degrees “laying flat” from the operating orientation of the seal assembly 17. The method may include removing the expandable member 122 from the seal assembly 17 (e.g., by removing one or more sets of fasteners 216 that secure the expandable member 122 to the first rigid member 100 and the third rigid member 112).

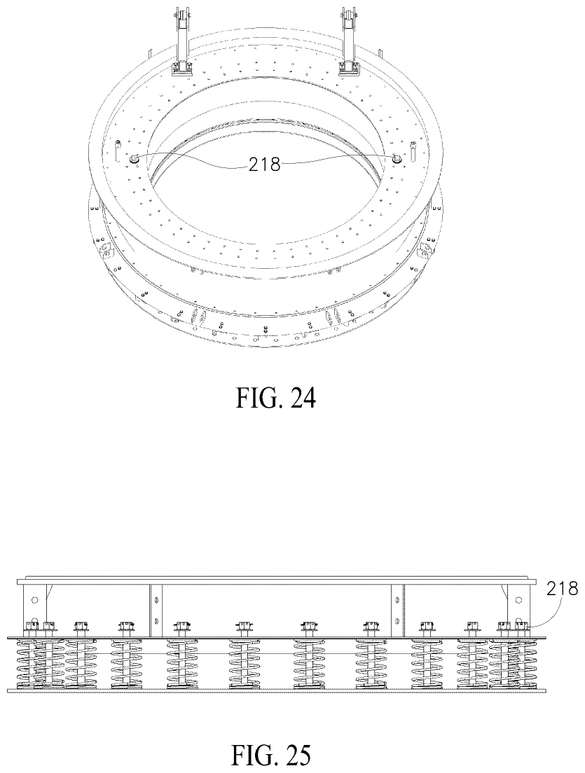

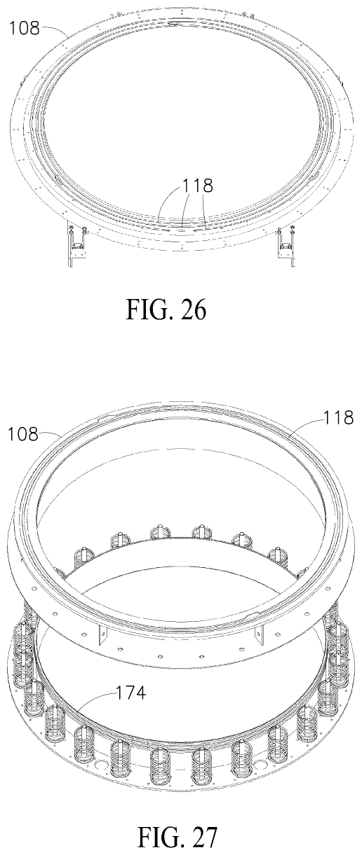

As shown in FIG. 23, the method may include actuating the turnbuckles 130 until the biasing members 114 are fully extended (i.e., exert no outward force on adjacent components). Additional internal fasteners 218 (e.g., as shown in FIGS. 24 and 25) may be removed to enable components of the seal assembly 17 to be disassembled until the compressible members 118 and the compressible members 174 (as shown in FIGS. 26 and 27) are exposed and accessible. As shown, different ones of the compressible members 118 may be carried by separate stationary components 108. Once the compressible members 118 and the compressible members 174 are accessible, they may be removed and replaced. The method may include reassembling and/or reattaching the seal assembly 17 to the system 10. According to one embodiment, reassembling and reattaching the seal assembly 17 to the system 10 includes performing the previous steps of disassembly and detachment in reverse order.

Although embodiments of the systems and methods described herein are illustrated in the figures as including reactor drums which rotate about a horizontally aligned axis of rotation, it is appreciated that in some embodiments, the axis of rotation may be inclined, or vertical. In such embodiments, gravity and/or gas velocity may play a significant role in transporting the biomass particles through the reactor drum. In addition, although embodiments of the systems and methods are described herein as involving a heated gas stream passing through the reactor drum to carry or transport the biomass particles while simultaneously transferring heat to the biomass particles to torrefy them, it is appreciated that in some embodiments the biomass particles may be transported by alternate mechanisms (e.g., gravity, screw devices, conveyor devices, etc.) and subjected to a counter-flowing heated gas stream within the reactor drum to torrefy the biomass particles.

Moreover, the various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A seal assembly comprising:
a first rigid member including a first rigid body and a first hole extending through the first rigid body;
a second rigid member including a second rigid body and a second hole extending through the second rigid body;
a third rigid member including a third rigid body and a third hole extending through the third rigid body;
at least one compressible member positioned between and abutting both the second rigid member and the third rigid member such that an airtight seal is formed between the second rigid member and the third rigid member; and
at least one biasing member positioned between the first rigid member and the second rigid member such that the at least one biasing member exerts a force that biases the third rigid member away from the first rigid member and toward the second rigid member,
wherein the seal assembly includes an expanded configuration in which the second rigid member is rotatable relative to both the first rigid member and the third rigid member, and the third rigid member is translatable relative to the first rigid member.

2. The seal assembly of claim 1 wherein the second rigid member is rotatable about an axis of rotation that passes through the first hole, the second hole, and the third hole, and the third rigid member is translatable relative to the first rigid member along a direction that is parallel to the axis of rotation.

3. The seal assembly of claim 2, further comprising a positive pressure zone formed between the first rigid body and the third rigid body, the positive pressure zone positioned between an inner volume of the seal assembly and an external environment surrounding the seal assembly with respect to a radial ray extending from the axis of rotation, the positive pressure zone sealed off from both the inner volume and the external environment, and the positive pressure zone having a higher pressure than both the inner volume and the external environment.

4. The seal assembly of claim 3 wherein the at least one biasing member is positioned within the positive pressure zone.

5. The seal assembly of claim 3 wherein a seal between the positive pressure zone and the inner volume is formed between two surfaces that are translate relative to one another.

6. The seal assembly of claim 3, further comprising a gas injector that provides passage for an inert gas into the positive pressure zone.

7. The seal assembly of claim 1 wherein the seal assembly includes a contracted configuration in which the second rigid member is non-rotatable relative to both the first rigid member and the third rigid member, and the second rigid member is translatable relative to the first rigid member.

8. The seal assembly of claim 7, further comprising a tensioner coupled to both the first rigid body and the second rigid body, thereby preventing relative rotation of the first rigid member and the second rigid member.

9. The seal assembly of claim 8 wherein the tensioner is coupled to both the first rigid body and the second rigid body such that actuation of the tensioner translates at least one of the first rigid member and the second rigid member toward the other of the first rigid member and the second rigid member, thereby reducing a length measured from the first rigid member to the second rigid member along the direction of translation, and thereby transitioning the seal assembly from the expanded configuration to the contracted configuration.

10. The seal assembly of claim 1, further comprising a wear detector that measures a size of a gap surfaces of the second rigid member and the third rigid member that abut the at least one compressible member.

11. A method of performing maintenance on a system that includes a stationary component and a rotatable component, the method comprising:
attaching a tensioner to a first rigid body and a second rigid body, thereby preventing rotation of the second rigid body relative to the first rigid body;
removing fasteners that coupled the first rigid body to the stationary component of the system;
actuating the tensioner to translate the first rigid body toward the second rigid body, thereby compressing a biasing member that is positioned between the first rigid body and the second rigid body;
removing fasteners that coupled the second rigid body to the rotatable component of the system; and
simultaneously moving both the first rigid body and the second rigid body relative to both the rotatable component of the system and the stationary component of the system.

12. The method of claim 11 wherein compressing the biasing member exerts a force on a third rigid body thereby urging the third rigid body towards the second rigid body, the force compressing a compressible member positioned between the second rigid body and the third rigid body.

13. The method of claim 12 wherein attaching the tensioner to the first rigid body and the second rigid body includes attaching the tensioner to a first bracket secured to the first rigid body and attaching the tensioner to a second bracket secured to the second rigid body, the method further comprising:
rotating the second rigid body relative to the first rigid body, thereby aligning the first bracket and the second bracket, prior to attaching the tensioner to the first rigid body and the second rigid body.

14. The method of claim 13 wherein the tensioner is a first tensioner, the method further comprising:
attaching a second tensioner to the first rigid body and the second rigid body;
actuating the second tensioner to translate the first rigid body toward the second rigid body, thereby compressing the biasing member;
after actuating the first tensioner and the second tensioner, detaching the first tensioner from the first rigid body and the second rigid body; and
after detaching the first tensioner, attaching a lifting arm to the first bracket and the second bracket,
wherein simultaneously moving both the first rigid body and the second rigid body relative to both the rotatable component of the system and the stationary component of the system includes applying a force to the lifting arm.

15. The method of claim 12, further comprising:
depressurizing a positive pressure zone formed between the first rigid body and the third rigid body, the positive pressure zone having a higher pressure than an external environment surrounding the system prior to depressurization, wherein depressurizing the positive pressure zone includes equalizing pressure within the positive pressure zone with the external environment.

16. The method of claim 15 wherein depressurizing the positive pressure zone includes decoupling a gas injector that provides passage for an inert gas into the positive pressure zone from an inert gas source.

17. The method of claim 16, further comprising:
reorienting the first rigid body and the second rigid body such that the force exerted on the third rigid body by the biasing member is perpendicular to a previous direction along which the force was exerted on the third rigid body.

18. The method of claim 17, further comprising:
detaching any tensioners and other components preventing relative movement of the first rigid body and the second rigid body; and
removing the second rigid body from contact with the compressible member.

19. The method of claim 18, further comprising:
removing the compressible member from a groove formed in the third rigid body;
placing a replacement compressible member in the groove;
abutting the replacement compressible member with the second rigid body; and
reattaching the detached tensioners to the first rigid body and the second rigid body such that the replacement compressible member is captured between the second rigid body and the third rigid body.

20. (canceled)

21. The method of claim 11 wherein the system is a torrefaction, gasification, or pyrolysis system.
